(19) United States
(12) Patent Application Publication
(10) Pub. No.: US 2021/0342483 A1
(43) Pub. Date: Nov. 4, 2021

(54) DETECTION AND MODIFICATION OF PRIVACY SETTINGS

(71) Applicant: Hewlett-Packard Development Company, L.P., Spring, TX (US)

(72) Inventors: Thomas Flynn, Spring, TX (US); Harold Merkel, Houston, TX (US); Rahul V. Lakdawala, Spring, TX (US); Charles J. Stancil, Spring, TX (US)

(73) Assignee: Hewlett-Packard Development Company, L.P., Spring, TX (US)

(21) Appl. No.: 17/285,504

(22) PCT Filed: Dec. 11, 2018
(86) PCT No.: PCT/US2018/065007

§ 371 Date: Apr. 15, 2021

(51) Int. Cl. G06F 21/62

(52) U.S. Cl. CPC G06F 21/6263

(57) ABSTRACT

An example of a computer-readable medium storing machine-readable instructions. When executed, the instructions may cause detection of an access to a resource with a privacy setting. The instructions may cause the modification of the privacy setting to a new value.

### BACKGROUND

Applications and websites may collect personal information about users. The applications and websites may include privacy settings to allow a user to modify what data is collected or what data is shared with other entities.

### BRIEF DESCRIPTION OF THE DRAWINGS

Various examples will be described below referring to the following figures:

FIG. 1 shows a computer system in communication with a server over a network in accordance with various examples;

FIG. 2 shows a method of detecting access to a resource and modifying a privacy setting of the resource in accordance with various examples;

FIG. 3 shows a method of receiving a privacy data set to detect an application and modify an application privacy setting of the application in accordance with various examples; and

FIG. 4 shows a method of detecting an application and modifying a user privacy setting of the application.

### DETAILED DESCRIPTION

Applications and websites may have access to personal data about their users. Cell phones may provide applications with data about the location of the user, websites may use cookies to track the user's activities, or applications may collect data regarding the user's computer system and use of the application. The applications or websites may have privacy settings that allow a user to modify what data is collected or how it is used. Different applications and websites may have different privacy settings that are accessed and modified in different ways. A user may not even know an application or website collects personal data or has privacy settings to modify.

A privacy manager may be used to manage privacy settings across various websites and applications. The privacy manager may include a privacy data set that includes information about websites and applications. The information may allow the privacy manager to detect the applications or access to the websites and notify users of data collection. The information may allow the privacy manager to modify the privacy settings of the applications and websites, providing a unified interface for the user to modify the user's privacy settings.

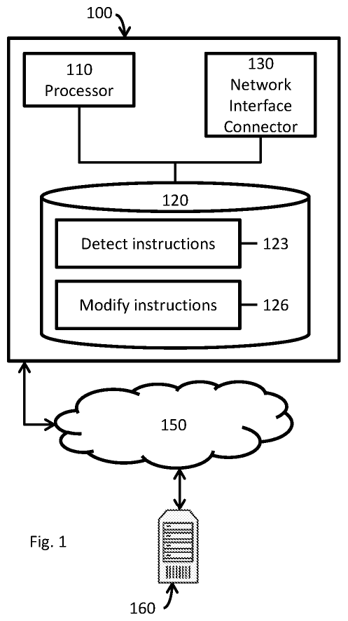

FIG. 1 shows a computer system 100 in communication with a resource 160 over a network 150 in accordance with various examples. The computer system 100 includes a processor 110, storage 120, and a network interface connector 130.

Computer system 100 may include a server, a laptop or desktop computer, a tablet, or another electronic device. The processor 110 may comprise a microprocessor, a microcomputer, a microcontroller, a field programmable gate array (FPGA), or discrete logic to execute machine-readable instructions. The storage 120 may include a hard drive, solid state drive (SSD), flash memory, electrically erasable programmable read-only memory (EEPROM), or random access memory (RAM). The network interface connector 130 may couple the computer system 100 to a resource 160. The connection may be via a network 150, which may include the Internet. The resource 160 may be a server, a printer, storage, or other kind of resource.

Storage 120 may include detect instructions 123 and modify instructions 126. The detect instructions 123 and modify instructions 126 may include instructions to implement the methods described herein. The detect instructions 123 may include instructions for detecting an application or access to a resource 160. The modify instructions 126 may include instructions to modify privacy settings associated with the application or resource 160.

Computer system 100 may be used to implement the methods described herein, such as the methods described in connection with the other figures. Machine-readable instructions to implement the methods may be stored in the storage 120 and executed by the processor 110.

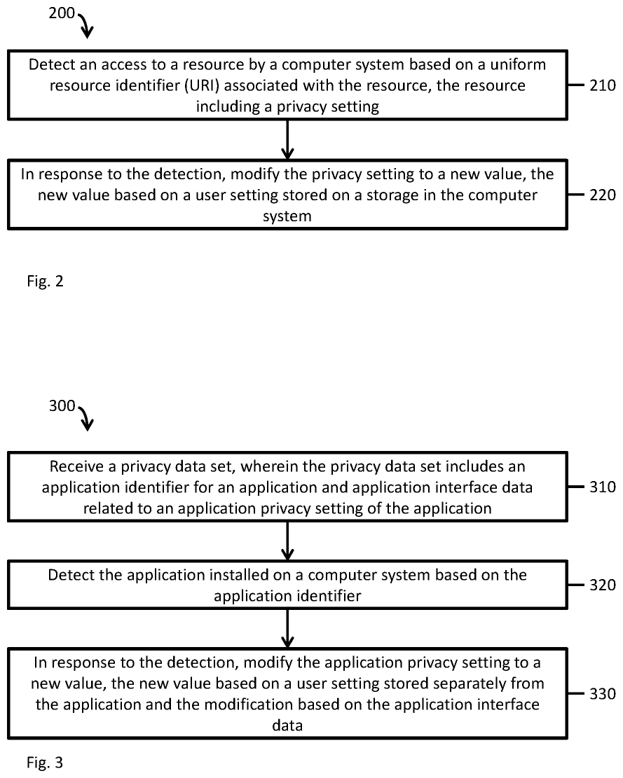

FIG. 2 shows a method 200 of detecting access to a resource and modifying a privacy setting of the resource in accordance with various examples. Method 200 includes detecting an access to a resource by a computer system based on a uniform resource identifier (URI) associated with the resource, the resource including a privacy setting (210). Method 200 includes, in response to the detection, modifying the privacy setting to a new value, the new value based on a user setting stored on a storage in the computer system (220).

A URI may be used to identify a resource. The resource may be local to a computer system or accessible over a network, such as the Internet. A uniform resource locator (URL) is a type of URI. A URL may be used to identify a website. A URI may identify resources other than websites, such as a printer or a web-based application. A website or web-based application may be provided through a server accessible over the Internet.

Access to a URI may be detected. For example, this may be done by hooking into a computer system's network driver stack to identify the URIs to which network messages are sent or from which they are received. Applications, such as web browsers, may also provide notifications when URIs are accessed.

A privacy manager may have a set of URIs which it may handle. The URIs may correspond to various resources, such as websites, devices, or applications accessible over the Internet. One URI may correspond to an online shopping website. Another URI may correspond to an Internet search provider. URIs may, for example, correspond to a social media site, a video streaming site, or a service platform such as a reservation service. The privacy manager may be able to handle more URIs than a user actually accesses. A user may access URIs that the privacy manager cannot handle.

In various examples, when a user accesses a resource the privacy manager cannot handle, a warning may be provided. The warning may be in the form of a pop-up message indicating the privacy manager is unable to manage privacy settings associated with the resource. The warning may be in the form of a visual indicator on the screen, such as an icon next to the URL listed in a web browser. The privacy manager may prevent access to a resource it does not know how to handle. A user may be able to override such prevention. The privacy manager may collect data about resources a user attempts to access that the privacy manager does not know how to handle. This may allow the developers of the privacy manager application to add management of those resources to the privacy manager.

In various examples, the privacy manager may be a background application that runs on a computer system. The privacy manager may be an add-in to an existing application, such as an add-in for a web browser.

To detect an access to a resource, the privacy manager may have a privacy data set that includes URIs. The privacy manager may compare the URI of a resource being accessed against the URIs in the privacy data set. For example, this may be performed by implementing a hash table of the URIs the privacy manager can handle and using a hash of the URI of a resource as an index into the hash table. The privacy data set may include individual URIs or ranges of URIs.

In various examples, the privacy manager may be able to detect applications installed on a computer system. The privacy data set may include application identification data used to identify applications. The application identification data may include a name of an application or a unique identifier of the application. The privacy manager may be able to search through the registry of a computer or query the operating system (OS) if an application is installed.

In various examples, the privacy data set may also include information about the data collected by the resource of a URI or an application. The privacy manager may inform the user of such data collection practices, such as by providing an indicator on a web browser that the user can click for more information about the current web site being accessed.

The privacy data manager may provide settings to allow a user to define a set of general privacy settings for applications or URIs. This may provide a unified interface where the user indicates what personal data may or may not be collected. The privacy manager may be able to apply these general settings across multiple applications or URIs. For example, the general privacy setting may be used to modify a first user privacy setting of a first application and a second user privacy setting of a second application.

In various examples, the general settings may not exactly match the privacy settings of the applications or websites. The privacy data set may include information about mapping a user's general settings to privacy settings specific to the resources or applications. For example, the privacy manger may provide settings for providing full location information, anonymized location information, or no location information to an application on a cell phone. A mapping application may use those same privacy settings. In that case, the privacy manager may modify the settings of the mapping application to match the user's selection. A mapping application may instead have settings to allow collection of data within an accuracy of a mile, 500 feet, 5 feet, or no collection of data, allowing the mapping application to know where you are with varying degrees of precision, but not allowing collection of anonymized data. In such a case, the privacy manager may convert a setting of providing full location to allowing collection of data with the greatest accuracy. The privacy manager may convert a setting of providing no location information to no collection of data by the mapping application. As there is no option for anonymized data, the mapping application may convert the user's setting of allowing anonymized data into a setting of no collection of data by the mapping application. A second privacy setting of a second application, such as an application providing discounts to nearby stores, may also be set based on the privacy manager's general setting. The second application may have a privacy setting related to location that corresponds to the privacy manager's general setting, or the privacy setting for the second application may also be mapped to a corresponding setting.

When a resource is accessed through its URI, the privacy manager may detect the access. In response, the privacy manager may interact with the resource, such as via network calls, to modify the privacy settings for the user. The modification of the privacy settings may occur without the user's interaction. In various examples, a user may provide login information to allow a modification of the privacy settings. The login information may be provided at the time the resource is accessed or it may be provided as part of configuration of the privacy manager. The privacy manager may prompt the user for unknown login information upon access to the resource and store it for use on a subsequent access. The privacy manager's modification of the privacy settings may be transparent to the user.

When an application is detected, the privacy manager may modify the application's privacy settings according to the user's general settings. This modification may be performed when the application is detected or when the application is executed. The modification may be performed programmatically, such as by interfacing with an application programming interface (API) of the application in a way that is transparent to the user.

The privacy manager may store the privacy data set and the user's privacy settings on a storage. The storage may be stored on a local storage of the computer system being used, on a removable storage such as a universal serial bus (USB) stick, or on a network location such as cloud storage. If stored on cloud storage or a removable storage, the privacy data set or user's privacy settings may be temporarily stored in local storage of the computer system being used. The user's privacy settings may be stored separately from the application. For example, the application may have an application settings file where it stores the privacy settings used by the application. The privacy manager may have a separate privacy manager settings file to store the user's privacy settings to be used in modifying the application privacy settings. The two files may be stored on the same storage, but may be stored separately as different files.

The privacy data set may include identifying information for URIs and applications managed by the privacy manager. The privacy data set may include information for accessing and changing the privacy setting of the resources and applications. The privacy data set may include information for converting between the privacy manager's general privacy settings and specific privacy settings used by the resources and applications.

In various examples, the user may be able to set different privacy settings for different applications or websites. For example, a user may have a general setting to not allow tracking cookies from websites, but may allow a specific online shopping site to use them to provide better suggestions for purchases. The privacy manager would handle tracking cookies and tracking cookie settings differently for the specific online shopping sites than for other websites. Specific settings may also allow a user to select settings options specific to the resource or application. Returning to the example of the mapping application, a user could have a setting specific for a mapping application to allow for data collection within 1 mile of accuracy, even though no corresponding selection exists in the general settings.

In various examples, the privacy manager may cleanup data previously collected by an application or URI. This may include deleting data or requesting the deletion of data through an API. For example, when the privacy manager is first installed, the user may configure it to allow for no collection of location data. A mapping application on a cell phone may have stored two years of location data prior to installation of the privacy manager. The privacy manager may cause the deletion of such previously collected data.

In various examples, the privacy manager may notify the user of the privacy settings of an application or resource. This may include describing what information is collected, how it is used, what information has been previously collected, and effects of changing the privacy settings to different values. The privacy manager may detect when an application or resource modifies a privacy setting, such as when an application is updated. The privacy manager may notify the user of the change and modify the privacy setting of the application or resource back, based on the general or specific privacy settings selected by the user in the privacy manager.

FIG. 3 shows a method 300 of receiving a privacy data set to detect an application and modify an application privacy setting of the application in accordance with various examples. Method 300 includes receiving a privacy data set, wherein the privacy data set includes an application identifier for an application and application interface data related to an application privacy setting of the application (310). Method 300 includes detecting the application installed on a computer system based on the application identifier (320). Method 300 includes, in response to the detection, modifying the application privacy setting to a new value, the new value based on a user setting stored separately from the application and the modification based on the application interface data (330).

In various examples, the privacy manager may modify the privacy settings of a URI or application at different times. For example, the privacy manager may modify the settings of an application when it is detected as installed on a computer system. The privacy manager may delay modifying the settings of an application until the application is executed. The privacy manager may receive notifications of changes to the privacy settings of the application or may check the privacy settings from time to time to make sure they have not been changed. If the privacy settings are changed, the privacy manager may ask if the user changed the privacy setting and potentially update the privacy settings data for the privacy manager.

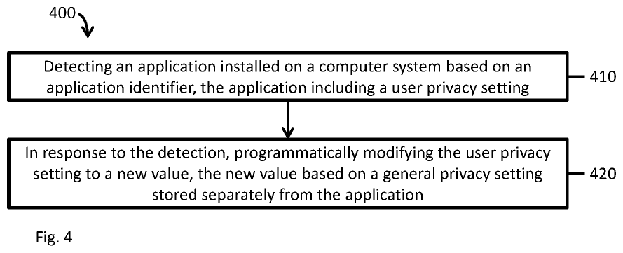

FIG. 4 shows a method 400 of detecting an application and modifying a user privacy setting of the application. Method 400 includes detecting an application installed on a computer system based on an application identifier, the application including a user privacy setting (410). Method 400 includes, in response to the detection, programmatically modifying the user privacy setting to a new value, the new value based on a general privacy setting stored separately from the application (420).

In various examples, the privacy manager may receive an updated privacy data set describing resources and applications. An updated privacy data set may indicate that an application or resource has changed its API for modifying privacy settings or modified its set of privacy settings. This may cause the privacy manager to access the application or resource and modify the application or resource privacy settings based on the user's privacy settings. The privacy manager may access the application or resource upon receipt of the updated privacy data set or delay access till the application or resource is next used by a user.

In various examples, the privacy manager may receive an updated privacy data set indicating an application has modified its privacy settings. For example, an application may previously have allowed submission of anonymized location information. The privacy manager may have set the application's privacy setting to allow for sharing anonymized location information. The application may be updated to remove the option of sharing anonymized location information. Instead, the options may be full sharing of location information or no sharing of location information. After receiving an update privacy data set regarding the application's updated privacy settings, the privacy manager may modify the application's privacy setting to no sharing of location information, based on the user's general privacy setting of allowing anonymized sharing of data.

In various examples, the privacy manager may be usable by multiple users of a computer system. The users may have different general and specific privacy settings stored by the privacy manager. The privacy manager may detect which user is logged into the computer system to determine which set of privacy settings to apply to various applications or resources. Some applications or resources may not allow setting privacy settings independently for different users of the same computer system. In such cases, the privacy manager may select the most restrictive privacy setting indicated by any user.

In various examples, the privacy data set may include a large amount of data. A caching mechanism may be used where a cached privacy data set is stored on a local computer system. The cached privacy data set may include information regarding applications currently installed on the computer system and resources frequently accessed by users. The privacy manager may access a larger privacy data set whenever a new application is installed or an infrequently accessed resource is accessed. The privacy manager may delay accessing the larger privacy data set, such as accessing it once per day to check for such applications or resources. In such cases, the privacy manager may, transparently to the user, access the application or resource to modify the privacy settings and perform a deletion of data that was collected.

In various examples, the privacy manager may store privacy settings that are specific to an application. The application-specific privacy settings may override corresponding general privacy settings for a specific application. For example, a coupon application may request location information for an application providing coupons to nearby stores, while a mapping application may request location information to provide directions to locations. A user may have a general privacy setting that applications can have location of the user with an accuracy of 10 miles. That general privacy setting may be used with the coupon application. The user may specify that the mapping application use a different setting for location information, namely providing full access to location information. In setting the privacy setting for the mapping application, the privacy manager may use the application-specific privacy setting for the mapping application instead of the corresponding general privacy setting.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A computer-readable medium to store machine-readable instructions that, when executed by a processor, cause the processor to:
detect an access to a resource by a computer system based on a uniform resource identifier (URI) associated with the resource, the resource including a privacy setting;
in response to the detection, modify the privacy setting to a new value, the new value based on a user setting stored on a storage in the computer system.

2. The computer-readable medium of claim 1, wherein execution of the machine-readable instructions causes the processor to:
detect an application installed on the computer system based on application identification data; and
in response to the detection of the application, modify an application privacy setting of the application to a new application value, the new application value based on the user setting, the user setting being stored separately from the application.

3. The computer-readable medium of claim 2, wherein the modification of the privacy setting and the modification of the application privacy setting occur transparently to a user.

4. The computer-readable medium of claim 1, wherein execution of the machine-readable instructions causes the processor to notify a user of the computer system regarding the privacy setting.

5. The computer-readable medium of claim 1, wherein execution of the machine-readable instructions causes the processor, in response to the detection, to request deletion of privacy data gathered by the resource.

6. A computer-readable medium to store machine-readable instructions that, when executed by a processor, cause the processor to:
receive a privacy data set, wherein the privacy data set includes an application identifier for an application and application interface data related to an application privacy setting of the application;
detect the application installed on a computer system based on the application identifier; and
in response to the detection, modify the application privacy setting to a new value, the new value based on a user setting stored separately from the application and the modification based on the application interface data.

7. The computer-readable medium of claim 6, wherein the privacy data set includes a uniform resource indicator (URI) for a resource and URI interface data related to a resource privacy setting of the resource.

8. The computer-readable medium of claim 7, wherein execution of the machine-readable instructions causes the processor to:
detect an access to the resource based on the URI; and
in response to the detection, modify the resource privacy setting to a new privacy value, the new privacy value based on a second user setting stored separately from the resource and the modification based on the URI interface data.

9. The computer-readable medium of claim 6 wherein execution of the machine-readable instructions causes the processor to delete privacy data gathered by the application in response to the detection.

10. The computer-readable medium of claim 6, wherein the user setting includes a first user setting for a first user and a second user setting for a second user, and the new value is based on the first user setting and based on the first user being logged into the computer system.

11. A method comprising:
detecting an application installed on a computer system based on an application identifier, the application including a user privacy setting; and
in response to the detection, programmatically modifying the user privacy setting to a new value, the new value based on a general privacy setting stored separately from the application.

12. The method of claim 11 comprising programmatically modifying a second user privacy setting of a second application to a second new value, the second new value based on the general privacy setting.

13. The method of claim 11 comprising programmatically modifying a second user privacy setting of a second application to a second new value, the second new value based on an application-specific privacy setting for the second application, the application-specific privacy setting stored separately from the second application.

14. The method of claim 11 comprising, in response to a notification of an application update, programmatically modifying the user privacy setting to the new value.

15. The method of claim 11 comprising:
selecting the new value based on the general privacy setting, the new value and the general privacy setting being distinct;
receiving updated data regarding the application;
selecting a second new value based on the general privacy setting, the selecting the second new value being based on the updated data; and
programmatically modifying the user privacy setting to the second new value.
